(19) United States
(12) Patent Application Publication
(10) Pub. No.: US 2007/0228967 A1
(43) Pub. Date: Oct. 4, 2007

(54) Plasma display panel (PDP)

(76) Inventor: Sang-Hyun Kim, Suwon-si (KR)

Correspondence Address: Robert E. Bushnell, Suite 300, 1522 K Street, N.W., Washington, DC, 20005, US

(21) Appl. No.: 11/727,571

(22) Filed: Mar. 27, 2007

(30) Foreign Application Priority Data
Mar. 29, 2006 (KR) 10-2006-0028284

(51) Int. Cl. H01J 17/49

(52) U.S. Cl. 313/582; 313/587

(57) ABSTRACT

A Plasma Display Panel (PDP) includes: a front substrate having a first color tone; a rear substrate facing the front substrate; address electrodes arranged on the rear substrate and extending in a first direction; display electrodes arranged on the front substrate and extending in a second direction intersecting the address electrodes; a dielectric layer arranged on the front substrate to cover the display electrodes, the dielectric layer having a second color tone; barrier ribs arranged between the front and rear substrates to define discharge cells at intersection regions of the address and display electrodes, the barrier ribs having a third color tone to be subtractive-mixed with the first and second color tones; and phosphor layers arranged in the discharge cells.

### CLAIM OF PRIORITY

This application makes reference to, incorporates the same herein, and claims all benefits accruing under 35 U.S.C.§119 from an application for PLASMA DISPLAY PANEL earlier filed in the Korean Intellectual Property Office on the 29 of Mar. 2006 and there duly assigned Serial No. 10-2006-0028284.

### BACKGROUND OF THE INVENTION

1. Field of the Invention

The present invention relates to a Plasma Display Panel (PDP) and, more particularly, the present invention relates to a PDP which prevents reduced display quality due to external light reflection.

2. Description of Related Art

Generally, a Plasma Display Panel (PDP) is a display device that can display an image using red, green and blue visible light created by exciting phosphors using Vacuum UltraViolet (VUV) rays emitted from a plasma generated by a gas discharge.

The PDP can realize a large-sized screen over 60 inches while having a thickness of only 10 cm. Like a Cathode Ray Tube (CRT), the PDP is also a self-emissive display. Therefore, the PDP has an excellent color reproduction and has no image distortion viewed from any angle. The manufacturing process of the PDP is simpler than that of a Liquid Crystal Display (LCD) and thus the PDP has advantages in terms of the manufacturing cost and productivity. As a result, the PDP has been recently widely used in many fields.

In a conventional Alternating Current (AC) 3-electrode surface-discharge PDP, a pair of electrodes is formed on a front substrate. Address electrodes are provided on a rear substrate spaced apart from the front substrate. A plurality of discharge cells defined by barrier ribs are formed along intersecting regions of the electrodes and the address electrodes. Phosphor layers are formed in the discharge cells. The discharge cells are filled with a discharge gas.

Millions or more of the discharge cells are arranged in a matrix pattern in the PDP. The PDP selects the discharge cells that will be turned on using a memory property of wall charges. The image is displayed by discharging the selected discharge cells.

While the image is displayed on a front surface of the PDP, external light emitted from a variety of external light sources is introduced into the PDP through the front surface. Some of the light that is being introduced into the PDP is reflected and is mixed with visible light for displaying the image, thereby reducing the display quality of the PDP.

### SUMMARY OF THE INVENTION

According to an embodiment of the present invention, a Plasma Display Panel (PDP) includes: a front substrate having a first color tone; a rear substrate facing the front substrate; address electrodes arranged on the rear substrate and extending in a first direction; display electrodes arranged on the front substrate and extending in a second direction intersecting the address electrodes; a dielectric layer arranged on the front substrate to cover the display electrodes and having a second color tone; barrier ribs arranged between the front and rear substrates to define discharge cells at intersection regions of the address and display electrodes and having a third color tone to be subtractive-mixed with the first and second color tones; and phosphor layers arranged in the discharge cells.

A color tone resulting from a mixture of the first and second color tones may be complementary with the third color tone.

The first color tone may be one of cyan, magenta, and yellow colors that are subtractive mixture primary colors.

The second color tone may be another one of subtractive mixture secondary colors that are obtained by mixing at least two of the subtractive mixture primary colors that are complementary with the first color tone.

The second color tone may be one of subtractive mixture secondary colors obtained by mixing at least two of the red, green and blue colors.

The first color tone may be one of subtractive mixture secondary colors obtained by mixing at least two of the subtractive mixture primary colors.

The first color tone may be one of subtractive mixture secondary color obtained by mixing at least two of the red, green, and blue colors.

The second color tone may be one of subtractive mixture primary color obtained by mixing at least two of cyan, magenta, and yellow colors that are complementary to the second color tone.

In another exemplary embodiment of the present invention, a Plasma Display Panel (PDP) includes: a front substrate having a first color tone; a rear substrate facing the front substrate; barrier ribs that define discharge cells between the front and rear substrates and having a second color tone; phosphor layers arranged in the discharge cells; address electrodes arranged on the rear substrate and extending in a first direction; a pair of display electrodes arranged on the front substrate and extending in a second direction intersecting the address electrodes; a dielectric layer arranged on the front substrate to cover the display electrodes and having a third color tone to be be subtractive-mixed with the first and second color tones.

The first color tone may be one of cyan, magenta, and yellow colors that are subtractive mixture primary colors, the second color tone may be another one of the cyan, magenta, and yellow colors, and the third color tone may be the other of the cyan, magenta, and yellow colors.

The first color tone may be the cyan color. The second color tone may be the yellow color.

A light transmittance of the front substrate may be less than 92% and a light transmittance of the dielectric layer may be equal to or greater than 65%. A total light transmittance of the front substrate and the dielectric layer may be between 59 and 60%.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partly exploded perspective view of a Plasma Display Panel (PDP) according to a first exemplary embodiment of the present invention;

FIG. 2 is a sectional view taken along line II-II of FIG. 1;

FIG. 3 is a top plane view illustrating a complementary color relationship between a front substrate and an upper dielectric layer of the PDP of FIGS. 1 and 2;

FIG. 4 is a side sectional view of a PDP according to a second exemplary embodiment of the present invention; and

FIG. 5 is a top plane view illustrating a complementary color of the PDP of FIG. 4.

### DETAILED DESCRIPTION OF THE INVENTION

The present invention is described more fully below with reference to the accompanying drawings, in which exemplary embodiments of the present invention are shown. The present invention may, however, be embodied in many different forms and should not be construed as being limited to the embodiments set forth herein; rather these embodiments are provided so that this disclosure will be thorough and complete, and will fully convey the concept of the present invention to those skilled in the art. Wherever possible, the same reference numbers will be used throughout the drawings to refer to the same or like parts.

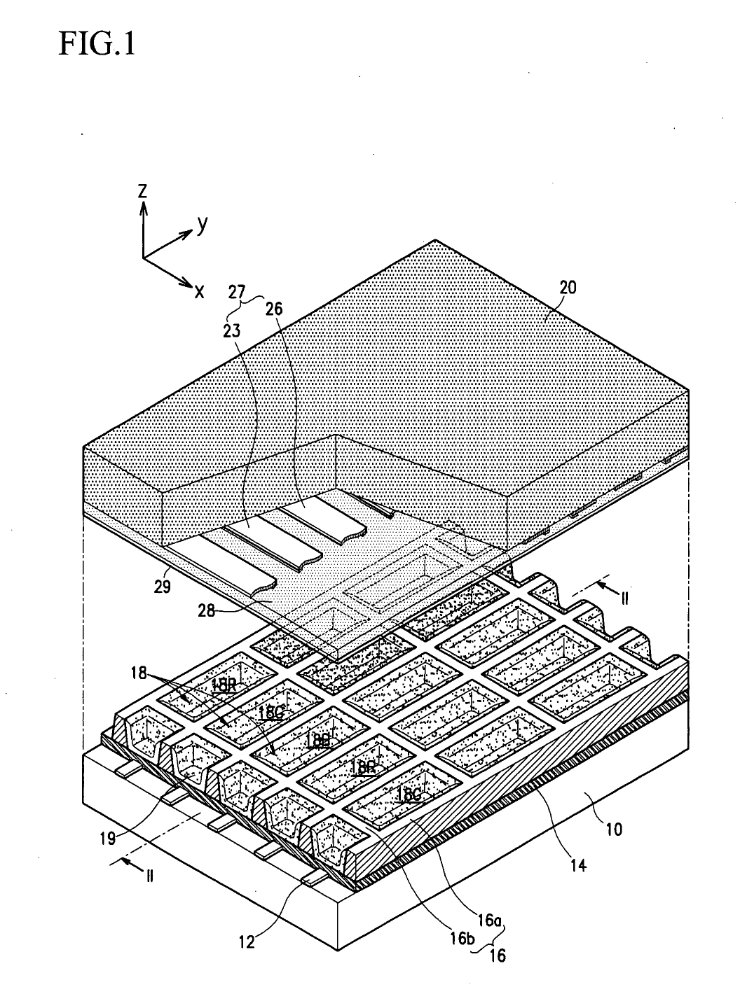

FIG. 1 is a partly cut-away perspective view of a Plasma Display Panel (PDP) according to a first exemplary embodiment of the present invention.

Referring to FIG. 1, a PDP includes rear and front substrates 10 and 20 facing each other and spaced apart from each other. The front substrate 20 is colored with a first color tone.

The first color tone of the front substrate 20 is complementary with a second color tone of an upper dielectric layer 28. Therefore, the first color tone is subtractive-mixed with the second color tone, thereby preventing a reduction in the display quality of the PDP due to external light reflection.

A plurality of discharge cells 18 are defined by barrier ribs 16 between the rear and front substrates 10 and 20.

The barrier ribs 16 include longitudinal barrier ribs 16a extending in a first direction (a y-axis in FIG. 1) and lateral barrier ribs 16b extending in a second direction (an x-axis in FIG. 1) perpendicularly intersecting the longitudinal barriers 16a. Therefore, the discharge cells 18 defined by the longitudinal and lateral barrier ribs 16a and 16b are arranged in a matrix pattern.

However, the PDP of the present invention is not limited to the above. That is, the discharge cells 18, defined by the barrier ribs, may be arranged in a variety of patterns, such as stripe patterns or delta patterns.

The discharge cells 18 define respective sub-pixels, each of which is a minimum unit for displaying an image. One pixel is defined by two or more sub-pixels. Phosphor layers 19 for emitting visible light by absorbing vacuum ultraviolet rays created by a gas discharge are formed in the discharge cells 18.

The phosphor layers 19 are formed to provide red, green, and blue discharge cells 18R, 18G, and 18B. A set of the red, green, and blue discharge cells 18R, 18G, and 18B defines one unit pixel.

The discharge cells 18 are filled with a discharge gas (e.g., a mixture gas including neon (Ne) and xenon (Xe)) to create vacuum ultraviolet rays using a gas discharge. The discharge cells 17 have phosphor layers 19 for absorbing the vacuum ultraviolet rays and emitting visible light.

The PDP includes address and display electrodes 12 and 27.

The address electrodes 12 are arranged on the rear substrate 10 and extend in a first direction (a y-axis) with respect to the discharge cells 18. Therefore, the address electrodes 12 are arranged in parallel between the longitudinal barrier ribs 16a.

The display electrodes 27 are arranged on the front substrate 20 and extend in a second direction intersecting the address electrodes 12. Each of the display electrodes 27 includes a pair of scan and sustain electrodes 23 and 26.

The address electrodes 12 intersect the display electrodes 27 at the respective discharge cells 18. The address and display electrodes 12 and 27 induce an address discharge for selecting the discharge cells 18 that will be turned on and a sustain discharge for displaying an image using the selected discharge cells 18.

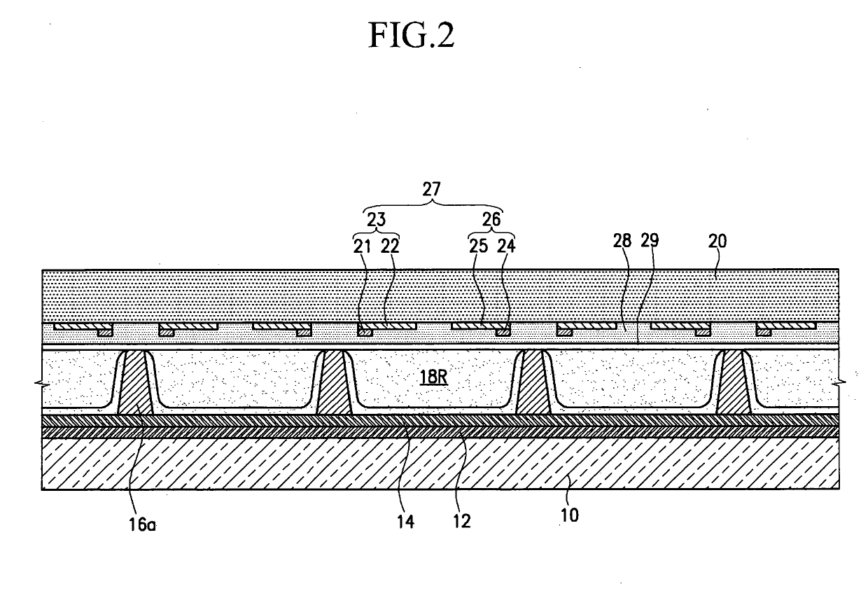

FIG. 2 is a sectional view taken along line II-II of FIG. 1.

Referring to FIG. 2, the addresses electrodes 12 are covered by a lower dielectric layer 14. The lower dielectric layer 14 protects the address electrodes 12 from the plasma discharge and accumulates electric charges. The barrier ribs 16 are formed on the lower dielectric layer 14 to define the discharge cells 16.

Each of the scan and sustain electrodes 23 and 26 respectively includes a bus electrode 21 and 24 extending along the lateral barrier rib 16b and a transparent electrode 22 and 25 extending from the bus electrode 21 and 24 toward a central portion of the discharge cell 18.

The bus electrodes 21 and 24 are formed of metal having a high electrical conductivity in order to compensate for the high electric resistance of the transparent electrodes 22 and 25.

At this point, the bus electrodes 21 and 24 are located near or along the lateral barriers 16b defining the discharge cells 18 to improve the transmittance of the visible light emitted from the discharge cells 18 by the plasma discharge.

The transparent electrodes 22 and 25 are formed of a transparent material, such as Indium Tin Oxide (ITO), to provide a sufficient aperture ratio for the discharge cells 17. The transparent electrodes 22 and 25 are arranged in a stripe pattern extending in a second direction along the bus electrodes 21 and 24 to generally correspond to the arrangement of the red, green and blue discharge cells 18R, 18G, and 18B.

However, the present invention is not limited to the above configuration. For example, the transparent electrodes 22 and 25 may individually correspond to the respective red, green and blue discharge cells 18R, 18G, and 18B.

An upper dielectric layer 28 is formed to cover the scan and sustain electrodes 23 and 26 to allow for the easy accumulation of the electric charges during the plasma discharge.

The upper dielectric layer 28 is colored with the second color tone that can be complementary with the first color tone of the front substrate 20.

The first color tone may be a cyan and the second color tone may be a red color that is complementary with the cyan.

However, the present invention is not limited to this configuration. For example, the first color tone of the front substrate 20 may be one of a cyan-based color, a magenta-based color, and a yellow-based color. In this case, the second color tone of the upper dielectric layer 28 may be one of subtractive mixture secondary colors mixed with subtractive mixture primary colors that are complementary with the first color tone.

Accordingly, the second color tone of the upper dielectric layer 28 may be a red-based color that is a complementary with cyan, a green-based color that is complementary with magenta, or a blue-based color that is complementary with yellow.

At this point, the red color is a secondary color obtained by subtractive-mixing the magenta color and the yellow color that are the primary colors. The green color is a secondary color obtained by subtractive-mixing the cyan color and the yellow that are the primary colors. The blue color is a secondary color obtained by subtractive-mixing the magenta color and the cyan color that are the primary colors.

The first color tone of the front substrate 20 may be one of the subtractive mixture secondary colors that are obtained by mixing at least two colors of the primary colors that are subtractive-mixed with each other. In this case, the second color tone of the upper dielectric layer maybe one of the subtractive mixture primary colors that are complementary with the subtractive mixture secondary color.

A passivation layer 29 is formed on the upper dielectric layer 28 to protect the upper dielectric layer 28 from the plasma discharge occurring in the discharge cells 18.

The passivation layer 29 may be a MgO layer having a relatively high visible light transmittance and a relatively high secondary electron emission coefficient. The MgO layer may reduce a firing voltage while protecting the upper dielectric layer 28.

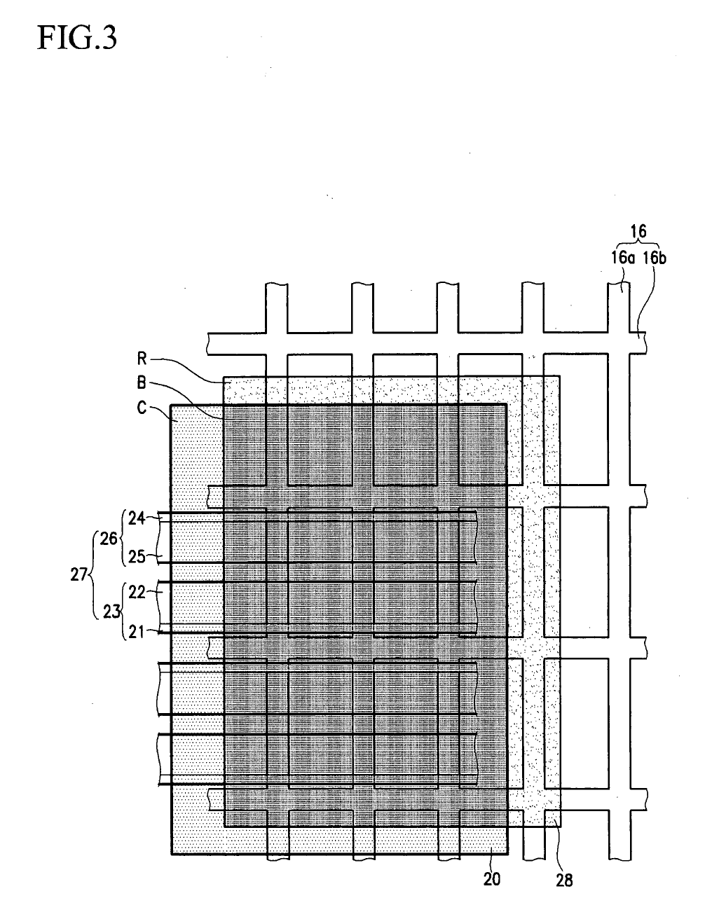

FIG. 3 is a top plane view illustrating a complementary color relationship between a front substrate and an upper dielectric layer of the PDP of FIGS. 1 and 2.

Referring to FIG. 3, the cyan color (C) of the front substrate 20 is subtractive-mixed with the red color (R) of the upper dielectric layer 28, thereby representing the black color (B).

Therefore, the front substrate 20 and the upper dielectric layer 28 form an external light reflection preventing layer that is black (B) above the barrier ribs 16 and the discharge cells 18 defined by the barrier ribs 16.

Since the front substrate 20 and the upper dielectric layer 28 form the external light reflection preventing layer, the external light introduced through the front substrate 200 is absorbed while passing through the front substrate 20 and the upper dielectric layer 28, thereby preventing a reduction in the display quality due to external light reflection.

Since the front substrate 20 and the upper dielectric layer 28 are subtractive-mixed with each other above the barrier ribs 16 and the discharge cells 18 and thus form the external light reflection preventing layer, the barrier ribs 16 may be formed of a dielectric material that is not colored and the phosphor layers 19 may be formed of a phosphor material containing a white-based powder having a high reflectivity.

Accordingly, even if a visible light transmittance from the discharge cells 18 is reduced due to the coloring of the front substrate 20 and the upper dielectric layer 28, the light luminance can be compensated for since the visible light absorption rate of the barrier ribs 16 is reduced. Furthermore, since the phosphor layers 19 having a high reflectivity can be formed in the discharge cells 18, the light luminance can be further improved.

The following is a description of a PDP according to a second embodiment of the present invention. In view of an overall structure and operational effect, the second embodiment is similar to the first embodiment. Therefore, the same reference numbers will be used to refer to the same or like parts and a description for the same or like parts has been omitted.

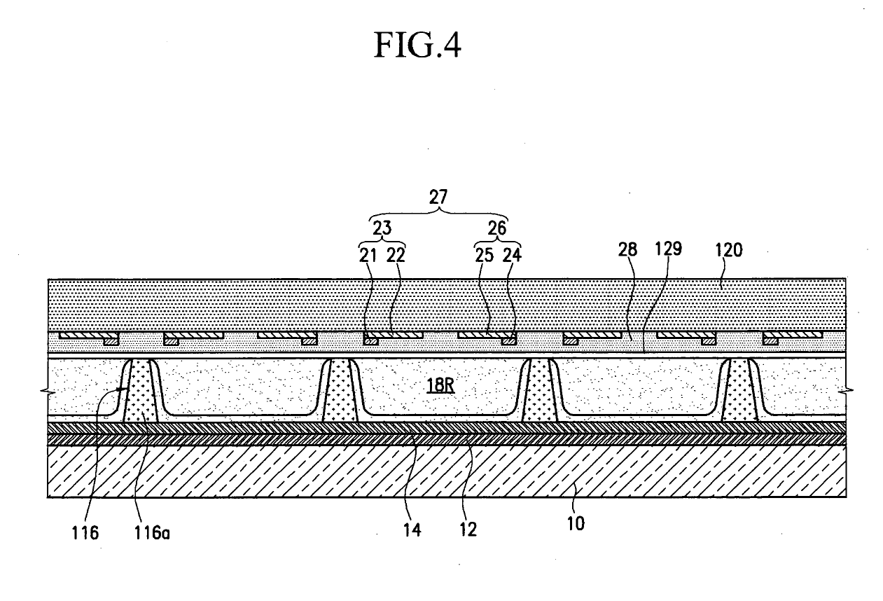

FIG. 4 is a side sectional view of a PDP according to a second exemplary embodiment lo of the present invention.

Referring to FIG. 4, a front substrate 120 is colored with a first color tone, an upper dielectric layer 128 is colored with a second color tone, and barrier ribs 116 are colored with a third color tone that can be subtractive-mixed with the first and second color tones.

The first, second and third color tones may be one of cyan (C), magenta (M), yellow (Y) colors that are subtractive mixture primary colors.

In the present exemplary embodiment, the front substrate 120 is colored with the cyan color (C). In this case, the upper dielectric layer 128 and the barrier ribs 116 are respectively colored with the magenta color (M) and the yellow color (Y) that can, when mixed with each other, represent the red color (R) that is complementary with the cyan color (C).

Particularly, when the front substrate 120 is colored with the cyan color (C), a color temperature increases and a visible light transmittance of the front substrate 120 may be less than 92%. The barrier ribs 116 may be colored with the yellow color that has a relatively low level of the visible light absorption rate.

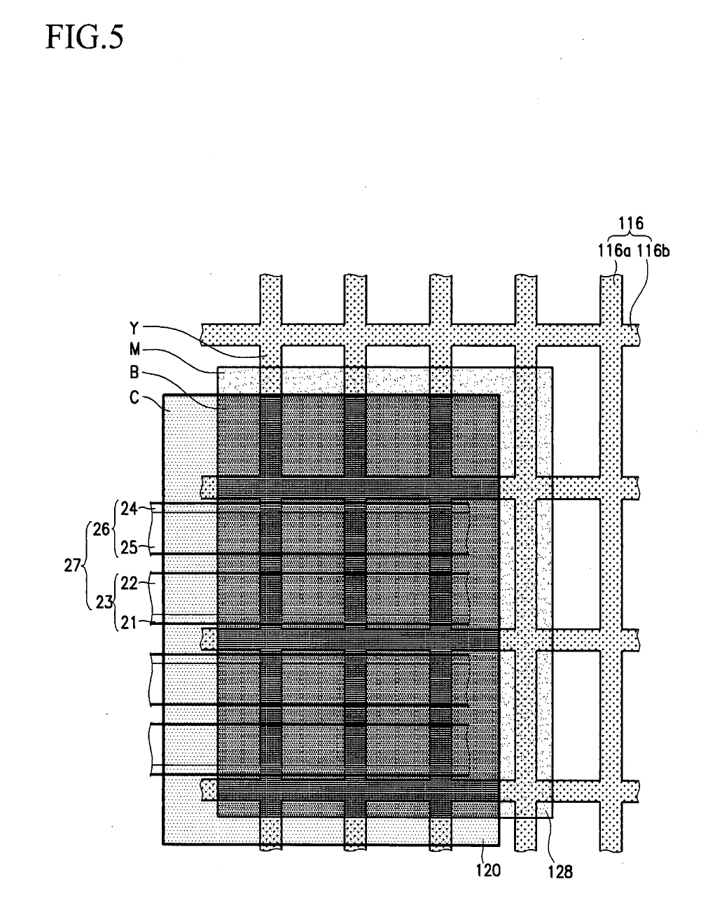

FIG. 5 is a top plane view illustrating a complementary color relationship of the PDP of FIG. 4.

Since the front substrate 120, the upper dielectric layer 128, and the barrier ribs 116 are respectively colored with the cyan (C), magenta (M), yellow (Y) colors that are subtractive mixture primary colors, the top surface of the barrier ribs represents the black color by the subtractive mixing of the three colors.

Therefore, the barrier ribs 116 representing the black color by the subtractive mixing of the three colors can have a similar external reflection preventing effect to the conventional barrier ribs that are colored with the black color (B).

Since the front substrate 120 and the upper dielectric layer 128 are colored with the subtractive mixture primary colors, a degree of coloring of the front substrate 120 and upper dielectric layer 128 is lowered and thus the transmittance for the visible light emitted from the discharge cells 18 can be enhanced.

That is, in the PDP according to this second embodiment, when the visible light transmittance of the front substrate 120 is 85% and the visible light transmittance of the upper dielectric layer 128 is 70%, 59.5% of the visible light can be transmitted through both of the front substrate 120 and upper dielectric layer 128.

Therefore, when the visible light transmittance of the front substrate 120 is less than 92% and the visible light transmittance of the upper dielectric layer 128 is equal to or greater than 65%, about 60% of the visible light can be transmitted through both of the front substrate 120 and upper dielectric layer 128.

Furthermore, since the barrier ribs 116 are colored with the subtractive mixture primary color, the visible light absorption rate of the barrier ribs 1 16 can be further lowered compared with the conventional barrier ribs colored with black.

As described above, according to the present invention, the percentage of the visible light that can be transmitted through the front substrate 120 and the upper dielectric layer 128 increases while the visible light absorption rate of the barrier ribs 116 is reduced, thereby improving the luminance and the light emission efficiency.

Although exemplary embodiments of the present invention have been described in detail hereinabove, it should be clearly understood that many variations and/or modifications of the basic inventive concept taught herein still fall within the spirit and scope of the present invention, as defined by the appended claims.

What is claimed is:

1. A Plasma Display Panel (PDP) comprising:
a front substrate having a first color tone;
a rear substrate facing the front substrate;
address electrodes arranged on the rear substrate and extending in a first direction;
display electrodes arranged on the front substrate and extending in a second direction intersecting the address electrodes;
a dielectric layer arranged on the front substrate to cover the display electrodes, the dielectric layer having a second color tone;
barrier ribs arranged between the front and rear substrates to define discharge cells at intersection regions of the address and display electrodes, the barrier ribs having a third color tone to be subtractive-mixed with the first and second color tones; and
phosphor layers arranged in the discharge cells.

2. The PDP of claim 1, wherein a color tone resulting from a mixture of the first and second color tones is complementary with the third color tone.

3. The PDP of claim 1, wherein the first color tone is one of cyan, magenta, and yellow colors that are subtractive mixture primary colors, the second color tone is another one of the cyan, magenta, and yellow colors, and the third color tone is the remaining one of the cyan, magenta, and yellow colors.

4. The PDP of claim 3, wherein the first color tone is the cyan color.

5. The PDP of claim 4, wherein the second color tone is the magenta color.

6. The PDP of claim 5, wherein the third color tone is the yellow color.

7. The PDP of claim 3, wherein a light transmittance of the front substrate is less than 92%.

8. The PDP of claim 3, wherein a light transmittance of the dielectric layer is equal to or greater than 65%.

9. The PDP of claim 3, wherein a total light transmittance of the front substrate and the dielectric layer is between 59 and 60%.

10. A Plasma Display Panel (PDP) comprising:
a front substrate having a first color tone;
a rear substrate facing the front substrate;
barrier ribs defining discharge cells between the front and rear substrates, the barrier ribs having a second color tone;
phosphor layers arranged in the discharge cells;
address electrodes arranged on the rear substrate and extending in a first direction:
a pair of display electrodes arranged on the front substrate and extending in a second direction intersecting the address electrodes; and
a dielectric layer arranged on the front substrate to cover the display electrodes, the dielectric layer having a third color tone to be subtractive-mixed with the first and second color tones.

11. The PDP of claim 10, wherein a color tone resulting from a mixture of the first and second color tones is complementary with the third color tone.

12. The PDP of claim 10, wherein the first color tone is one of cyan, magenta, and yellow colors that are subtractive mixture primary colors, the second color tone is another one of the cyan, magenta, and yellow colors, and the third color tone is the remaining one of the cyan, magenta, and yellow colors.

13. The PDP of claim 12, wherein the first color tone is the cyan color.

14. The PDP of claim 13, wherein the second color tone is the magenta color.

15. The PDP of claim 14, wherein the third color tone is the yellow color.

16. The PDP of claim 12, wherein a light transmittance of the front substrate is less than 92%.

17. The PDP of claim 12, wherein a light transmittance of the dielectric layer is equal to or greater than 65%.

18. The PDP of claim 12, wherein a total light transmittance of the front substrate and the dielectric layer is between 59 and 60%.
